(19) United States
(12) Patent Application Publication
(10) Pub. No.: US 2024/0299946 A1
(43) Pub. Date: Sep. 12, 2024

(54) READY TO USE ANALYZER CONTROL PRODUCT FOR CUA URINALYSIS INSTRUMENTS

(71) Applicant: Siemens Healthcare Diagnostics Inc., Tarrytown, NY (US)

(72) Inventor: Lloyd Schulman, Granger, IN (US)

(73) Assignee: Siemens Healthcare Diagnostics Inc., Tarrytown, NY (US)

(21) Appl. No.: 18/552,206

(22) PCT Filed: Mar. 28, 2022
(86) PCT No.: PCT/US2022/071375

§ 371 Date: Sep. 25, 2023

Related U.S. Application Data
(60) Provisional application No. 63/168,536, filed on Mar. 31, 2021.

(51) Int. Cl. B01L 3/00

(52) U.S. Cl. CPC B01L 3/5082; B01L 2200/148; B01L 2300/02; B01L 2300/042

(57) ABSTRACT

An analyzer control product provided with a sealed rack tube containing a preconfigured volume of analyzer control fluid is described. In particular, the rack tube is provided with a base portion; a top portion; and a sidewall extending from the base portion to the top portion, the sidewall having an inner peripheral surface and an outer peripheral surface, at least one of the inner peripheral surface and the outer peripheral surface in contact with the base portion to form a control fluid void. The analyzer control fluid is within the control fluid void. The analyzer control fluid has a preconfigured volume. A sealing member is attached to the top portion to seal the control void.

This application claims benefit under 35 USC § 119(e) of U.S. Provisional Application No. 63/168,536, filed Mar. 31, 2021. The entire contents of the above-referenced patent application(s) are hereby expressly incorporated herein by reference.

### BACKGROUND

The inventive concepts disclosed herein generally relate to analyzer control products for analyzers of reagent cards and/or reagent strips, and more particularly, but not by way of limitation, to a ready to use analyzer control product.

To satisfy the needs of the medical profession as well as other expanding technologies, such as the brewing industry, chemical manufacturing, etc., a myriad of analytical procedures, compositions, and tools have been developed. Regardless of whether lateral flow immunoassays, or dip-and-read test devices are used for the analysis of a biological fluid or tissue, or for the analysis of a commercial or industrial fluid or substance, the general procedure involves a test device coming in contact with the sample or specimen to be tested, and manually or instrumentally analyzing the test device.

Diagnostic methods may include testing a sample to measure sample properties and/or to detect substances of interest that may be present in the sample. In the field of urinalysis, urine chemistry and sediments are commonly analyzed. The liquid sample usually contains one or more analytes/particles of interest. For urine chemistry analysis, the presence and concentrations of the analytes of interest in the sample are determinable by an analysis of the color changes undergone by the test device that has been submerged in the liquid sample.

For urine sediment analysis, the presence and concentrations of the particles of interest are measured by microscopic image analysis. These analyses may be done manually or using an automated analysis device.

Samples are presented to the analysis device via a sample rack that holds multiple sample collection units known as rack tubes. A conveyor may be used to present the sample rack to a test region of the test device. When the sample rack is in the proper position, the test is carried out using analytical tools typical of such tests. In order to stabilize the sample collection units during this process, clips are used to hold the sample collection units in place in the sample rack.

Dip-and-read reagent test devices enjoy wide use in many analytical applications, especially in the chemical analysis of biological fluids, because of their relatively low cost, ease of usability, and speed in obtaining results. In medicine, for example, numerous physiological functions can be monitored merely by dipping a dip-and-read reagent test device into a sample of body fluid or tissue, such as urine or blood, and observing a detectable response, such as a change in color or a change in the amount of light reflected from, or absorbed by the test device.

Many of the dip-and-read reagent test devices for detecting body fluid components are capable of making quantitative, or at least semi-quantitative, measurements. Thus, by measuring the detectable response after a predetermined time, a user can obtain not only a positive indication of the presence of a particular constituent in a test sample, but also an estimate of how much of the constituent is present. Such dip-and-read reagent test devices provide physicians and laboratory technicians with a facile diagnostic tool, as well as with the ability to gauge the extent of disease or bodily malfunction.

Illustrative of dip-and-read reagent test devices currently in use are products available from Siemens Healthcare Diagnostics Inc., under the trademark MULTISTIX, and others. Immunochemical, diagnostic, or serological test devices, such as these usually include one or more carrier matrix, such as absorbent paper, having incorporated therein a particular reagent or reactant system which manifests a detectable response (e.g., a color change in the visible or ultraviolet spectrum) in the presence of a specific test sample component or constituent. Depending on the reactant system incorporated with a particular matrix, these test devices can detect the presence of glucose, ketone bodies, bilirubin, urobilinogen, occult blood, nitrite, and other substances. A specific change in the intensity of color observed within a specific time range after contacting the dip-and-read reagent test device with a sample is indicative of the presence of a particular constituent and/or its concentration in the sample. Some other examples of dip-and-read reagent test devices and their reagent systems may be found in U.S. Pat. Nos. 3,123,443; 3,212,855; and 3,814,668, the entire disclosures of which are hereby incorporated herein by reference.

Testing tools and methods have been sought in the art for economically and rapidly conducting multiple tests, especially via using automated processing. Automated analyzer systems have an advantage over manual testing with respect to cost per test, test handling volumes, and/or speed of obtaining test results or other information.

Another development is the introduction of multiple-profile reagent cards and multiple-profile reagent card automated analyzers. Multiple-profile reagent cards are essentially card-shaped test devices which include multiple reagent-impregnated matrices or pads for simultaneously or sequentially performing multiple analyses of analytes, such as the one described in U.S. Pat. No. 4,526,753, for example, the entire disclosure of which is hereby incorporated herein by reference. The reagent pads on the multiple-profile reagent card are typically arranged in a grid-like arrangement and spaced at a distance from one another so as to define several rows and columns of reagent pads. Adjacent reagent pads in the same row may be referred to as a test strip, and may include reagents for a preset combination of tests that is ran for each sample, for example.

Multiple-profile reagent cards result in an efficient, economical, rapid, and convenient way of performing automated analyses. An automated analyzer configured to use multiple-profile reagent cards typically takes a multiple-profile reagent card, such as from a storage drawer, or a cassette, and advances the multiple-profile reagent card through the analyzer over a travelling surface via a card moving mechanism, typically one step at a time so that one test strip (or one row of reagent pads) are positioned at a sample-dispensing position and/or at one or more read position. Exemplary card moving mechanisms include a conveyor belt, a ratchet mechanism, a sliding ramp, or a card-gripping or pulling mechanism. As the multiple-profile reagent card is moved or travels along the travelling surface and is positioned at the sample-dispensing position, one or more pipettes (e.g., manual or automatic) deposits a volume of one or more samples on one or more of the reagent pads on the reagent card. Next, the reagent pads are positioned at one or more read positions and analyzed (e.g., manually or automatically) to gauge the test result. The reagent card is placed in the field of view of an imaging system, such as an optical imaging system, a microscope, or a photo spectrometer, for example, and one or more images of the reagent pads on the card (e.g., optical signals indicative of the color of the reagent pads) is captured and analyzed. Typically, the field of view of the imaging system is relatively large to allow for the capture of multiple images of the same reagent pad as the reagent card is moved or stepped across multiple read positions in the field of view of the imaging system. The field of view encompasses multiple read positions or locations, and each reagent pad is moved in a stepwise fashion through the read positions as the reagent card travels across the field of view of the imaging system. Because the analyzer moves the card between various read positions in known intervals of time, the multiple images taken in the field of view of the imaging system allow the analyzer to determine changes in the color of the reagent pad as a result of the reagent pad reacting with the sample at each read position as a function of the time it takes the pad to be moved to the respective read position, for example. Finally, the used card is removed from the analyzer, and is disposed of appropriately.

Other examples of automated diagnostic analyzers and their reagent systems may be found in U.S. Pat. Nos. 5,380,487; 5,130,095; 5,846,491; 9,632,103; and Publication No. 20140286124, the entire disclosure of which is hereby incorporated herein by reference.

Another conventional automated analyzer is a urinalysis analyzer sold under the trademark ICHEMVELOCITY by Beckman Coulter of Brea California. This analyzer accepts hundreds of test strips into the analyzer, with the test strips being fed through a track. The test strips have reagent-impregnated paper pads to perform chemical analysis of bilirubin, urobilinogen, ketones, ascorbic acid, glucose, protein, blood, pH, nitrite, leukocytes. The test strips incorporate a color compensation pad to address color interference. The analyzer does not apply automatic temperature correction on measured parameters. A pipette is used to pick up sample from a rack tube, and to dispense the sample onto reagent pads of a test strip. The analyzer has a strip reader module that measures the color of each pad of the test strips at different incubation times and uses these colors to obtain semi-quantitative concentrations. The condition and accuracy of this analyzer can be checked by performing control measurements using three bulk urine control solutions.

Automated analyzer systems need to be calibrated, or re-calibrated periodically. As an automated analyzer system is used, the sensor measuring the test device may experience sensor creep. In order to ensure analyses performed on a specimen is accurate, the automated analyzer system is calibrated.

Typically, automated analyzer system calibration requires that a technician fill a rack tube with bulk packaged analyzer control fluid and initialize a calibration feature of the automated analyzer system. However, errors occur during calibration if the technician places too small a volume of the analyzer control fluid in the rack tube or if the technician inadvertently contaminates the analyzer control fluid. Moreover, waste of product may occur if the technician places too large of a volume of the analyzer control fluid in the rack tube or it the technician inadvertently spills the analyzer control fluid, e.g., when attempting to fill the rack tube.

Accordingly, a need exists in the art for an analyzer control product that solves the issues with respect to the bulk packaged analyzer control fluid,

### SUMMARY

It is to such improvements that the present disclosure is directed. The problems associated with the bulk packaging of analyzer control fluid is solved by an analyzer control product provided with a sealed rack tube containing a preconfigured volume of analyzer control fluid. In particular, the rack tube is provided with a base portion; a top portion; and a sidewall extending from the base portion to the top portion, the sidewall having an inner peripheral surface and an outer peripheral surface, at least one of the inner peripheral surface and the outer peripheral surface in contact with the base portion to form a control fluid void. The analyzer control fluid is within the control fluid void. The analyzer control fluid has a preconfigured volume. A sealing member is attached to the top portion to seal the control void.

In another aspect, the problems associated with the bulk packaging of analyzer control fluid is solved by a method of calibrating an analyzer system comprising: placing at least one analyzer control product in a sample rack of a sample analyzer system and initializing a calibration process of the sample analyzer system. The analyzer control product includes a sealed rack tube containing a preconfigured volume of analyzer control fluid.

### BRIEF DESCRIPTION OF THE DRAWINGS

To assist those of ordinary skill in the relevant art in making and using the inventive concepts disclosed herein, reference is made to the appended drawings and schematics, which are not intended to be drawn to scale, and in which like reference numerals are intended to refer to the same or similar elements for consistency. For purposes of clarity, not every component may be labeled in every drawing. Certain features and certain views of the figures may be shown exaggerated and not to scale or in schematic in the interest of clarity and conciseness. In the drawings:

FIG. 1 is a schematic view of an exemplary embodiment of an automated analyzer system constructed in accordance with the present disclosure.

FIG. 2 is a front view of an exemplary embodiment of an analyzer device of the automated analyzer system shown in FIG. 1.

FIG. 3 is a perspective view of an exemplary embodiment of a sample rack of the automated analyzer system shown in FIG. 1.

FIG. 4 is a functional diagram of an exemplary embodiment of a computing system constructed in accordance with the present disclosure.

FIG. 5 is a flow diagram of an exemplary embodiment of a calibration process.

FIG. 6 is a front view of an exemplary embodiment of an analyzer control product constructed in accordance with the present disclosure.

FIG. 7A is a front view of an exemplary embodiment of a first top portion of a first rack tube and a first sealing member constructed in accordance with the present disclosure.

FIG. 7B is a front view of an exemplary embodiment of a second top portion of a second rack tube and a second sealing member constructed in accordance with the present disclosure.

FIG. 7C is a front view of an exemplary embodiment of a third top portion of a third rack tube and a third sealing member constructed in accordance with the present disclosure.

FIG. 7D is a front view of an exemplary embodiment of a fourth top portion of a fourth rack tube and a fourth sealing member constructed in accordance with the present disclosure.

FIG. 7E is a front view of an exemplary embodiment of a fifth top portion of a fifth rack tube and a fifth sealing member constructed in accordance with the present disclosure.

FIG. 8 is a process flow diagram of an exemplary embodiment of a user instantiated calibration process performed in accordance with the present disclosure.

FIG. 9 is a front perspective view of an exemplary embodiment of an analyzer control product kit.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting the inventive concepts disclosed and claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts disclosed herein may be practiced without these specific details. In other instances, well-known features have not been described in detail to avoid unnecessarily complicating the instant disclosure.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), a field programmable gate array (FPGA), a combination of hardware and software, and/or the like. The term “processor” as used herein means a single processor or multiple processors working independently or together to collectively perform a task.

Software may include one or more computer readable instructions that when executed by one or more components cause the component to perform a specified function. It should be understood that the algorithms described herein may be stored on one or more non-transitory computer readable medium. Exemplary non-transitory computer readable mediums may include random access memory, read only memory, flash memory, and/or the like. Such non-transitory computer readable mediums may be electrically based, optically based, magnetically based, and/or the like. Further, the messages described herein may be generated by the components and result in various physical transformations.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, a specimen is any sample that is tested by an analyzer system or analyzer device. A specimen may be a sample of body fluid or tissue, such as urine, blood or semen, interstitial fluid, organic chemical compounds, inorganic chemical compounds, any other sample having analytes of interest, or the like, or some combination or constituent thereof. In some embodiments, a specimen is a liquid specimen containing one or more constituents, substances, or properties of interest. The presence and concentrations of these constituents, substances, or properties of interest as determinable by the analyzer system. A specimen may have one or more properties such as color, specific gravity, or the like. A specimen may be a biological specimen, such as blood, semen, interstitial fluid, urine, or any other biological specimen, for example.

Turning now to the drawings, and in particular to FIG. 1, shown therein is a schematic view of an exemplary embodiment of an automated analyzer system 10 constructed in accordance with the present disclosure. Generally, the automated analyzer system 10 includes one or more analyzer device 14, shown in FIG. 1 as analyzer device 14a and analyzer device 14b, a computing device 18, a sample rack handler 22, and a sample rack system 26.

In one embodiment, the sample rack system 26 may include one or more sample rack 30 and one or more sample collection unit 34. Each sample collection unit 50 may contain a sample S for testing. In some embodiments, the sample S is a specimen. In other embodiments, the sample S is an analysis control fluid 38.

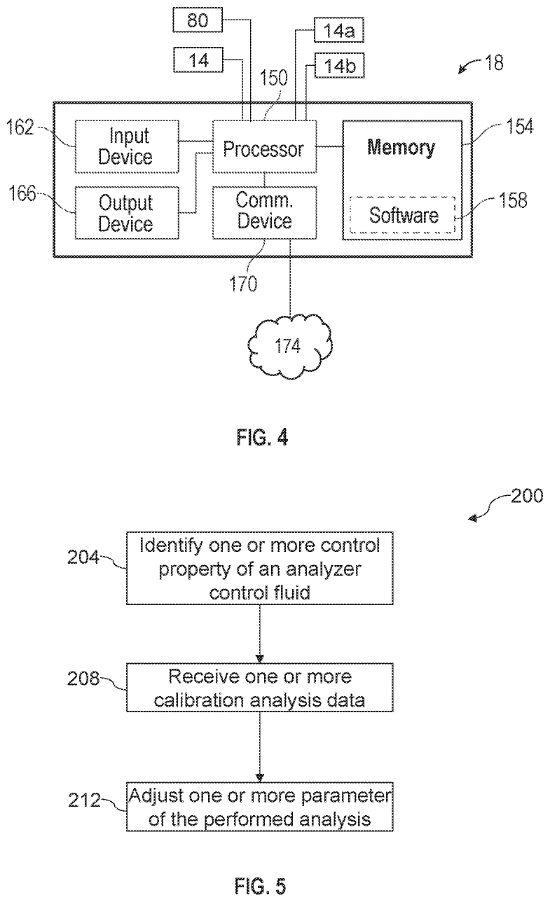

The computing device 18 (shown in FIG. 4 and described in more detail below) may be used to control operation of the sample analysis system 10. In some embodiment, the computing device 18 may be a separate component from the analyzer device 14a and the analyzer device 14b, as illustrated in FIG. 1. In another embodiment, the computing device 18 may be integrated in one or more component of the sample analysis system 10, such as in one or more of the analyzer device 14a and the analyzer device 14b. In yet another embodiment, one or more component of the computing device 18 may be integrated into one or more other component of the sample analysis system 10.

In one embodiment, the sample analysis system 10 may include at least one analyzer device 14, e.g., the analyzer device 14a and/or the analyzer device 14b. The analyzer device 14a and the analyzer device 14b are operable to analyze analytes of interest in the sample S contained in the one or more sample collection unit 34. For example, the analyzer device 14a may include a spectrophotometer (not shown) that determines a color of the sample S applied to one or more reagent pad of an analysis device, e.g., a test strip, by illuminating each reagent pad and reading one or more data, such as a reflectance property, of each illuminated reagent pad. Each reflectance property has a magnitude relating to a different wavelength of visible light.

In one embodiment, the analyzer device 14a and/or the analyzer device 14b may employ a variety of area array detection read-heads utilizing CCD (charge-coupled device), CID (charge-injection device) or PMOS detection structures for detecting color changes to each reagent pad. The detected color changes can be used to determine presence of analytes of interest. While a spectrophotometer is described above, other systems for analyzing a sample may be used in the sample analysis system 10 and the present disclosure is not limited to optical based systems.

In one embodiment, the analyzer device 14a may be used to obtain a first data from at least one sample S of a particular sample collection unit 34 of a particular sample rack 30. If the first data obtained by the analyzer device 14a indicates a need for further analysis of the at least one sample S, the particular sample rack 30 having the particular sample collection unit 34 is conveyed to the analyzer device 14a and further analyses are performed on the at least one sample S by the analyzer device 14b. However, it should be appreciated that the inventive concepts as described herein are not strictly limited to sample analysis systems that include two or more separate analysis devices 14 as described above.

In one embodiment, the sample rack handler 22 includes a base 42, a conveyor element 46 supported by the base 42 and one or more guide element 50. The one or more guide element 50 work with the conveyer element 46 to guide each sample rack 30 through the rack handler 22.

In one embodiment, the sample rack handler 22 includes an input staging area 54 where a particular sample rack 30 to be tested can be staged in the input staging area 54, and an output staging area 58 where the particular sample rack 30 is collected once testing is complete. The conveyer element 46 is designed to hold, and convey, multiple sample racks 30 from the input staging area 54 to the analyzer device 14a, from the analyzer device 14a to the analyzer device 14b, and further into the output staging area 58.

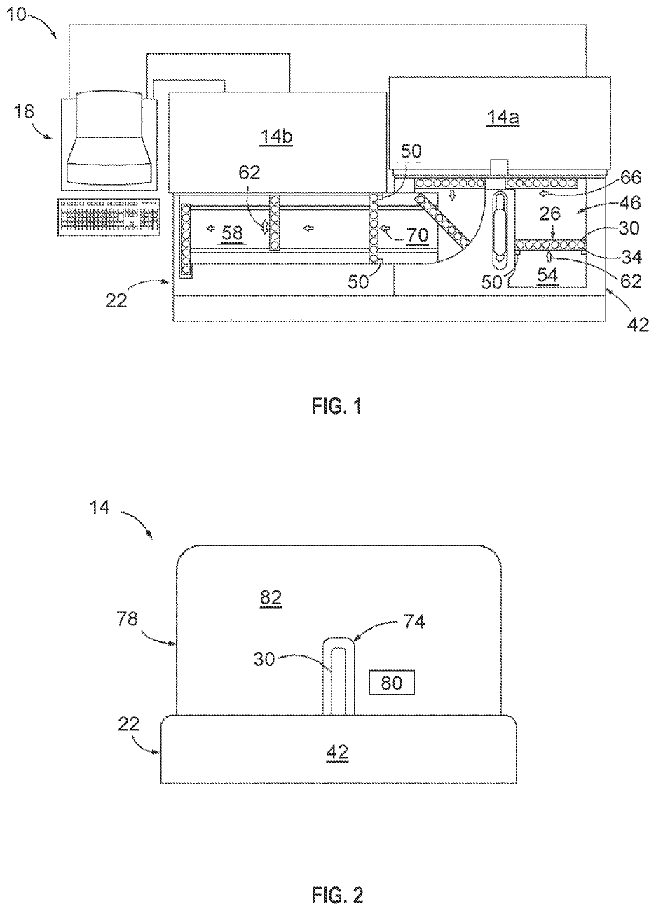

In one embodiment, as shown in FIG. 1, the conveyer element 46 and plurality of guide elements 50 advance the sample rack 30 to the analyzer device 14a in a first direction 62. The rack handler 22 then moves the sample rack 30 in a lateral direction 66 into a testing position proximate an analyzer in the analyzer device 14a. The rack handler 22 can then pivot the sample rack 30 so that sample rack 30 is positioned to travel in a second direction 70 that is perpendicular to first direction 62. The conveyer element 46 translates the sample rack 30 in the second direction 70. Once the sample rack 30 is positioned adjacent to a portal 74 (shown in FIG. 2), guide elements (not shown) pull the sample rack 30 along the first direction 62 into a housing 78 of the analyzer device 14b so that the sample S can be further analyzed.

In one embodiment, the rack handler 22 includes a serpentine travel path for the conveyor element. It should be appreciated that the inventive concepts disclosed herein are not limited to the specific conveyor path shown. For instance, the conveyer element 46 may have U shaped path in front of the analyzer device 14a. Furthermore, each analyzer device 14, such as the analyzer device 14a and the analyzer device 14b, may be separate analyzer devices 14 that are linked by a common conveyer element 46 as illustrated in the drawings. Accordingly, the sample rack system 26 as disclosed herein, which may include the sample rack 30, may be used with any type of sample analysis system that includes or utilizes one or more sample rack.

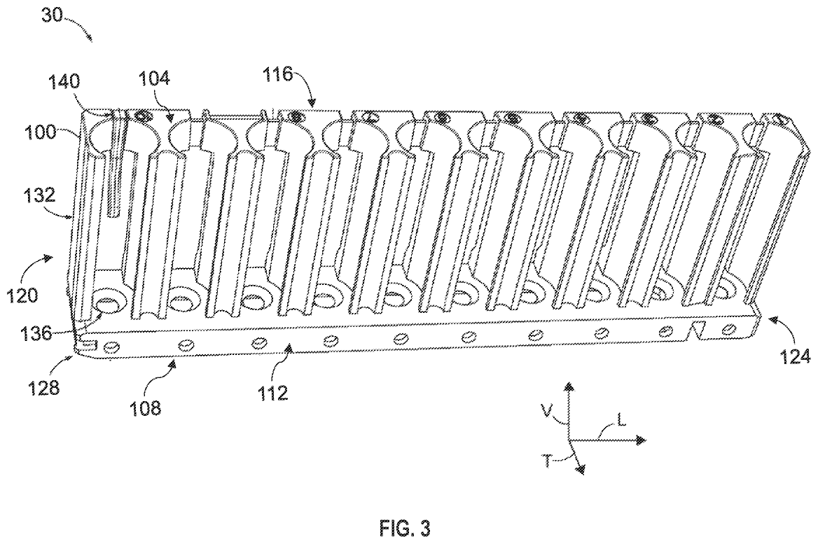

Referring now to FIG. 2, shown therein is an exemplary embodiment of the analyzer device 14 of FIG. 1 constructed in accordance with the present disclosure. The analyzer device 14 generally includes the housing 78 and the analyzer (not shown) contained in the housing 28. The housing 78 is coupled to the rack handler 22 and includes a front panel 82 near where the rack handler 22 is coupled to the analyzer device 14. The front panel 24 includes the portal 26 through which the sample rack 30 travels if it is determined that sample S in the sample rack 30 needs further analysis. The portal 74 is sized such that the sample rack 30 enters through the portal 74 into the housing 78 along a direction aligned with a length L (shown in FIG. 3) of the sample rack 30.

In one embodiment, the analyzer device 14 further includes an identifier reader 80, discussed in more detail below.

Referring now to FIG. 3, shown therein is a diagram of an exemplary embodiment of the one or more sample rack 30 of FIG. 1 constructed in accordance with the present disclosure. Each sample rack 30 includes a rack body 100 defining a top surface 104, a bottom surface 108 opposite the top surface 104 along a vertical direction V, a first side 112, and a second side 116 opposite the first side 112 along a transverse direction T that is perpendicular to the vertical direction V. The rack body 100 further includes a first end 120, and a second end 124 opposite the first end 120 along the longitudinal direction L that is perpendicular to the vertical direction V and the transverse direction T.

In one embodiment, as shown in FIG. 3, the rack body 100 further includes a base portion 128 that defines the bottom surface 108, and a rack portion 132 that extends upwardly from the base portion 128 along the vertical direction V. The rack portion 132 defines the top surface 104. The rack body 100 further defines at least one receptacle 136. Each receptacle 136 is sized and shaped to hold a sample collection unit 34. In accordance with the illustrated embodiment, the rack 30 includes 10 separate receptacles 136. However, the sample rack 30 may include less than ten receptacles, such as one receptacle 136, or more than ten receptacles 136.

In one embodiment, the sample rack 30 may include one or more retention clip 140. The retention clip 140 has a low-profile design, such that the retention clip 140 sits at or below the top surface 104 of sample rack 30. In this manner, the retention clip 140 avoids catching the front panel 82 of the analyzer device 14 when moving through the portal 74. In one embodiment, retention clip 140 avoids catching the housing 78 as the sample rack 30 is moved into the housing 78 of the analyzer device 14.

Referring now to FIG. 4, shown therein is a functional block diagram of an exemplary embodiment of the computing device 18 constructed in accordance with the present disclosure. The computing device 18 generally comprises a processor 150, a memory 154 storing a software 158, at least one input device 162 and at least one output device 166. In some embodiments, the computing device 18 may further include one or more communication device 170 operable to enable communication between the processor 150 and a network 174.

In one embodiment, the processor 150 may be operably coupled with the memory 154, the input device 162 to receive one or more input, and the output device 166 to output one or more data. The processor 150 may be communicably coupled to each analyzer system 14 such as the analyzer system 14a and the analyzer system 14b. In one embodiment, the processor 150 is in communication with the identifier reader 80 and can receive one or more identifier from the identifier reader 80.

In one embodiment, the input device 162 is capable of receiving information input from a user and/or the processor 150, and transmitting such information to other components of the sample analysis system 10. Implementations of the input device 162 may include, but are not limited to, a keyboard, a touchscreen, a mouse, a trackball, a microphone, a fingerprint reader, an infrared port, a slide-out keyboard, a flip-out keyboard, a cell phone, a PDA, a remote control, a fax machine, a wearable communication device, a network interface, a network connected device, combinations thereof, and/or the like, for example.

The output device 166 may be capable of outputting information in a form perceivable by the user, the processor 150, and/or another device such as a network connected device. For example, implementations of the output device 166 may include, but are not limited to, a computer monitor, a screen, a touchscreen, a speaker, a website, a television set, a smart phone, a PDA, a cell phone, a fax machine, a printer, a laptop computer, a network interface, a network connected device, combinations thereof, and/or the like, for example.

It is to be understood that in some exemplary embodiments, the input device 162 and the output device 166 may be implemented as an interface device, such as, for example, a touchscreen or bidirectional network connection. Additionally, in some embodiments, the computing device 18 may include more than one input device 162, more than one output device 166, or more than one interface device.

It is to be further understood that, as used herein, the term user is not limited to a human being, and may comprise a computer, a server, a website, a processor, a network interface, a human, a user terminal, a virtual computer, combinations thereof, and/or the like, for example.

The processor 150 may be implemented as a single processor or multiple processors working together or independently to execute processor executable code, such as the software 158. Embodiments of the processor 150 may include a digital signal processor (DSP), a central processing unit (CPU), a microprocessor, a multi-core processor, an application specific integrated circuit (ASIC), a field programmable gate array (FPGA), combinations thereof, and/or the like, for example. The processor 150 may be at the same location as the computing device 18, remote, that is, not at the same location as the computing device 18, or combinations thereof. For example, the processor 150 may be contained within the computing device 18, may be contained within the analyzer device 14, such as within either the analyzer device 14a and/or the analyzer device 14b, or may be remote an operably connected to the computing device 18, e.g., via the communication device 170 or the network 174, such as in a cloud-based computation service or other remote server, or some combination thereof.

In one embodiment, the memory 154 is a non-transitory computer readable medium and is implemented as RAM, ROM, flash memory and/or the like, and may take the form of a magnetic device, optical device, electrical device, crystalline device, or any other device operable to store processor executable instructions and information in a non-transitory manner, for example. The memory 154 can be a single non-transitory computer readable memory, or multiple non-transitory computer readable memories functioning logically together or independently, for example.

In one embodiment, the memory 154 includes one or more local non-transitory computer readable memory coupled to one or more remote non-transitory computer readable memory, such as a memory 154 of a cloud-service or other remote server in communication with the computing device 18. The memory 154 may store data, such as the software 158, in one or more data structure in the memory 154, for example, a file, a database, or RAW data such as in a partition table or bit-access location in the memory 154.

In one embodiment, the software 158 can be stored in the memory 154, read by the processor 150, and executed by the processor 150 to perform each process described herein. The software 158 may also include firmware, may be written in one or more programming language, and is program logic, for example, a set of instructions capable of being executed by the processor 150.

In one embodiment, the communication device 170 is operable to provide communication between the processor 150 and one or more connected device, such as via a network 174. The communication may be either bidirectional or monodirectional. The network 174 may be the internet and the sample analysis system 10 may be interfaced to the one or more connected device via the communication device 170. It should be noted, however, that the network 174 may be almost any type of network and may be implemented as the World Wide Web (or Internet), a local area network (LAN), a wide area network (WAN), a metropolitan network, a wireless network, a cellular network, a Global System for Mobile Communications (GSM) network, a code division multiple access (CDMA) network, a 3G network, a 4G network, a 5G network, a satellite network, a radio network, an optical network, a cable network, an Ethernet network, combinations thereof, and/or the like. It is conceivable that in the near future, embodiments of the present disclosure may use more advanced networking topologies.

In one embodiment, the communication device 170 provides one or more connection to the one or more other device without connecting to the internet. For example, the network 174 may be a connection between the communication device 170 and the one or more other device via any digital communications protocol. Non-limiting examples may include, for example, a connection between the communication device 170 of the sample analysis system 10 via a universal serial bus (USB) connection to a computer, a connection between the communication device 170 of the sample analysis system 10 via an optical communications protocol to one or more other device, a connection between the communication device 170 of the sample analysis system 10 and a display device, such as a monitor, and/or the like.

Referring now to FIG. 5, shown therein is a process diagram of an exemplary embodiment of a calibration process 200 performed in accordance with the present disclosure. In some embodiments, the processor 150 may perform the calibration process 200 before the analyzer device 14 performs a particular analysis on a specimen. The calibration process 200 may generally include the steps of: identifying one or more control property of an analyzer control fluid (step 204); receiving one or more calibration analysis data (step 208); and adjusting one or more parameter of the performed analysis (step 212).

In one embodiment, identifying one or more control property of an analyzer control fluid (step 204) may include first identifying the analyzer control fluid. Identifying the analyzer control fluid may include receiving an identifier affixed to the sample collection unit 30 and looking up the identifier in an analyzer control fluid database stored in the memory 155.

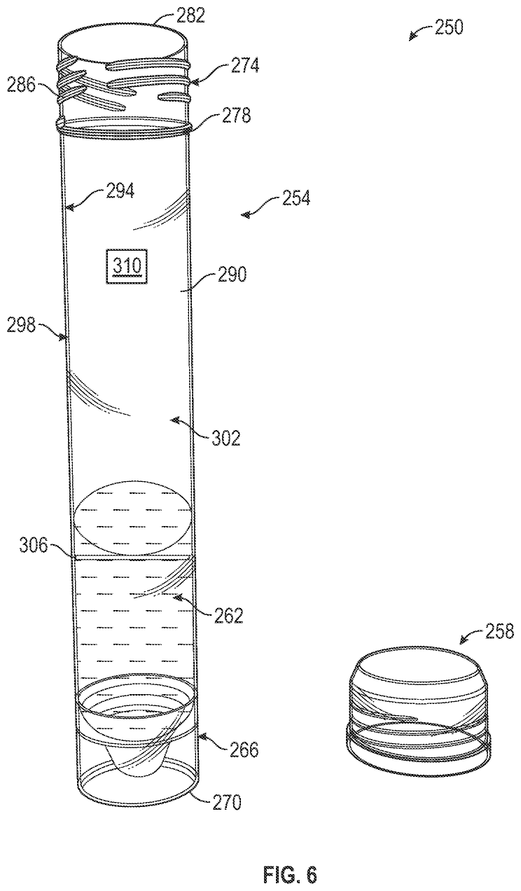

In one embodiment, the analyzer control fluid database may store information such as the one or more control property corresponding to an analyzer control product 250 and/or the analyzer control fluid having the identifier 310 (shown in FIG. 6 and discussed in more detail below). In one embodiment, the analyzer control fluid database may further associate the identifier 310 with lot information, such as a lot number, and an expiration date of an analyzer control product 250.

In one embodiment, receiving one or more calibration analysis data (step 208) may include receiving from the analyzer device 14, e.g., the analyzer device 14a and/or the analyzer device 14b, one or more calibration analysis data in response to a first analysis performed on the analyzer control fluid.

In one embodiment, if the one or more calibration analysis data received is substantially similar to the expected analysis data, the calibration process 200 ends without continuing to adjusting one or more parameter of the performed analysis (step 212).

In one embodiment, where the sample S in the sample collection unit 34 is a specimen, if the calibration process 200 is performed before a particular analysis is performed on the specimen, then the first analysis may be the same or similar to the particular analysis to be performed on the specimen.

In one embodiment, adjusting one or more parameter of the performed analysis (step 212) includes adjusting one or more parameter of the performed analysis based at least in part on the one or more control property and the one or more calibration analysis data. In one embodiment, the one or more parameter of the first analysis performed is adjusted such that a second analysis, similar to the first analysis and having one or more adjusted parameter, performed on the same or similar analyzer control fluid results in a second one or more calibration analysis data wherein the second one or more calibration data is substantially similar to the one or more expected analysis data.

In some embodiments, after adjusting one or more parameter of the performed analysis (step 212) is performed, the calibration process 200 is repeated, that is, after step 212, the calibration process 200 continues to step 204 to perform another iteration of the calibration process 200 with another analyzer control fluid.

Referring now to FIG. 6, shown therein is a front view of an exemplary embodiment of an analyzer control product 250 constructed in accordance with the present disclosure. The analyzer control product 250 generally comprises a rack tube 254, a sealing member 258, and the analyzer control fluid 262.

In one embodiment, the rack tube 254 generally comprises a base portion 266 having a base edge 270, a top portion 274 having a bottom 278, a top 282, and a sidewall 286 extending from the bottom 278 to the top 282. The rack tube 254 also includes a sidewall 290 extending from the base edge 270 of the base portion 266 to the bottom 278 of the top portion 274. The sidewall 290 further includes an inner peripheral surface 294 and an outer peripheral surface 298. At least one of the inner peripheral surface 294 and the outer peripheral surface 298 is in contact with the base portion 266 to form a control fluid void 302.

In one embodiment, the sealing member 258 is attached to the top portion 274 thereby sealing the control fluid void 302 such that the analyzer control fluid 262 is maintained in the control fluid void 302.

In one embodiment, the rack tube 254 may be constructed of any transparent or semi-transparent material that is chemically non-reactive to the analyzer control fluid 262. In one embodiment, the rack tube 254 is constructed of glass; however, in other embodiments, the rack tube 254 is constructed of plastic.

In one embodiment, the analyzer control fluid 262 is a liquid having known component concentrations. For example, the analyzer control fluid 262 may have known component concentrations mimicking the component concentrations routinely found in urine. Analyzing the analyzer control fluid 262 with the sample analysis system 10 is used to establish parameters for accuracy and precision of the analysis. The analyzer control fluid 262 includes one or more analyte and may include one or more filler and/or other non-reactive component, such as dye.

In some embodiments, the sample analysis system 10 is used for microscopic evaluation of urine sediment. Urinary sediment microscopy generally includes the detection and identification of analytes such as red blood cells, leukocytes, epithelial cells, bacteria, casts and crystals. In some embodiments, the analyzer control fluid 262 is prepared from human urine to which stabilized human red and white blood cells, calcium oxalate [dihydrate] crystals, non-pathogenic bacteria, and other compounds have been added to produce a desired reaction when analyzed or tested with a reagent. Exemplary analyzer control fluid 262 may include Chromascopics Urinalysis Control with Microscopics (a Quantimetrix product). In some embodiments, the analysis control fluid 262 may be used for confirmatory tests such as K-Check, Ictotest and for ßhCG screening methods.

In one embodiment, the analysis control fluid 262 has one or more property, including one or more expected analysis data based at least in part on known analytes and analyte concentrations in the analysis control fluid 262. In one embodiment, the memory 154 may store one or more expected analysis data for an analyzer control fluid, such as in a control fluid database. Each expected analysis data may include an analysis type and corresponding analysis information such as analyte type and expected analysis data for that analyte type.

In one embodiment, the expected analysis data is an expected range for each analyte in the analyzer control fluid. For example, the analyzer device 14, when performing an analysis on the analyzer control fluid, is expected to provide a value for one or more analyte in the analyzer control fluid. If each value for the one or more analyte is within the expected range for that analyte, the analyzer device 14 may be consider calibrated. However, if one or more value for the one or more analyte is not within the expected range for that analyte, the analyzer device 14 may be consider uncalibrated, or may not be considered calibrated.

In one embodiment, the rack tube 254 has one or more threshold indicator 306 disposed at a position between the bottom 278 of the top portion 286 and the bottom portion 266. The position of the threshold indicator 306 is selected such that a volume of the control fluid void 302 between the bottom portion 266 and the threshold indicator 306 is equal to or greater than a minimum volume of analyzer control fluid 262 required for the analyzer device 14 to perform a single calibration (i.e., process 200) and/or an analysis of the analyzer control fluid 262. The threshold indicator 306 may be positioned to indicate a volume in a range from 2 ml to 10 ml. For example, if the analyzer device 14 requires a volume of analyzer control fluid to be 2 ml to perform a calibration using the process 200, the threshold indicator 306 may be positioned between the bottom 278 of the top portion 286 and the bottom portion 266 such that a volume of analyzer control fluid 262 in the control fluid void 302 between the threshold indicator 306 and the bottom portion 266 is 2 ml. In some embodiments, when the analyzer control fluid 262 is used to calibrate for urine reagents, the volume of analyzer control fluid 262 in the control fluid void 302 can be 2 ml. In other embodiments, the volume of analyzer control fluid 262 in the control fluid void 302 can be 5 ml.

In one embodiment, the threshold indicator 306 is affixed to the outer peripheral surface 298. In another embodiment, the threshold indicator 306 is affixed to the inner peripheral surface 294. In one embodiment, the threshold indicator 306 is circumferentially affixed to the rack tube 254. In one embodiment, the threshold indicator 306 is embossed on the rack tube 254 while in another embodiment, the threshold indicator 306 is embedded in the rack rube 254. In one embodiment, the threshold indicator 306 is printed on the rack tube 254.

In one embodiment, the rack rube 254 further includes an identifier 310. The identifier 310 is configured to identify the analyzer control product 250. The processor 150 may receive the identifier 310 and determine, such as by accessing the memory 154 and/or the analyzer control fluid database, one or more property of the analyzer control fluid 262 in the analyzer control product 250. In one embodiment, the identifier 310 is one or more of a barcode, a quick response (QR) code, an image, an RFID chip, or the like. In one embodiment, the analyzer device 14 further includes the identifier reader 80 to read the identifier 310 and provide the identifier 310 to the processor 150. The identifier 310 may be visible to a user or may be a non-visible infrared identifier.

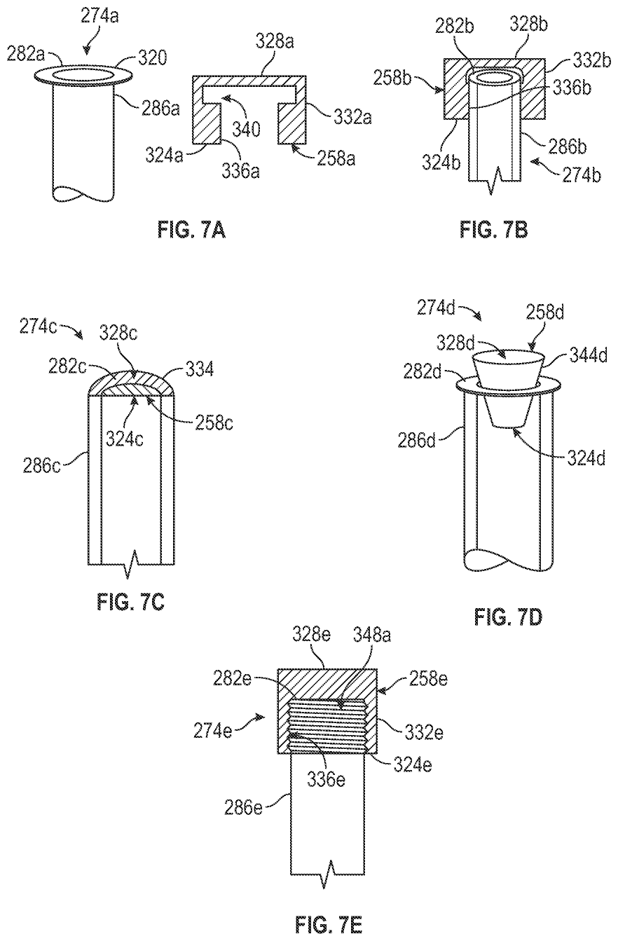

Referring now to FIGS. 7A-7E, shown there are various exemplary embodiments of the top portion 274 of the rack tube 254 and the sealing member 258. While five specific embodiments are shown, alternative configurations of the rack tube 254 and the sealing member 258 may be employed to cause the sealing member 258 to seal against the rack tube 254 thereby preventing any contamination from entering the control fluid void 302 or allowing any analyzer control fluid 262 in the control fluid void 302 from escaping the control fluid void 302 while the sealing member 258 is engaged.

Shown in FIG. 7A is a first top portion 274a having a ridge 320 formed circumferentially along a top 282a of sidewall 286a. A sealing member 258a constructed of a fluid and gas impermeable material includes a bottom 324a, a top 328a, an outer surface 332a and an inner surface 336a extending between the bottom 324a and the top 328a. The inner surface 336a is constructed to form an inner cavity 340 configured to receive the ridge 320 of the first top portion 274a so that the sealing member 258a engages and seals the top 282a of the first top portion 274a. In this embodiment, the sealing member 258a may be placed on or around the first top portion 274a to seal the top 282a of the top portion 274a and thereby maintain the analyzer control fluid 262 within the rack tube 252 of the analyzer control device 250.

Shown in FIG. 7B is a second top portion 274b having a top 282b and a sidewall 286b. A sealing member 258b constructed of a fluid and gas impermeable material includes a bottom 324b, a top 328b, an outer surface 332b and an inner surface 336b. The inner surface 336b is cylindrically shaped, and is configured to receive the second top portion 274b such that the inner surface 336b is in contact with the sidewall 286b forming a seal between the second top portion 274b and the sealing member 258b. In this embodiment, the sealing member 258b may be placed on or cap the second top portion 274b to seal the top 282b of the top portion 274b and thereby maintain the analyzer control fluid 262 within the rack tube 252 of the analyzer control device 250.

Shown in FIG. 7C is a third top portion 274c having a top 282c and a sidewall 286c. A sealing member 258c constructed of a fluid and gas impermeable material includes a bottom surface 324c, a top surface 328c, and an outer edge 344. The bottom surface 324c is configured to be adhered to the top 282c of the third top portion 274c such that the bottom surface 324c of the sealing member 258c is in contact with and seals against the top 282c of the third top portion 274c. In this embodiment, the sealing member 258c, such as a foil seal, may be stretched over and adhered to the third top portion 274c to seal the top 282c of the top portion 274c and thereby maintain the analyzer control fluid 262 within the rack tube 252 of the analyzer control device 250.

Shown in FIG. 7D is a fourth top portion 274d having a top 282d and a sidewall 286d. A sealing member 258d constructed of a fluid and gas impermeable material includes a bottom surface 324d, a top surface 328d, and an outer edge 344d. The sealing member 258d is configured to be at least partially inserted into the fourth top portion 274d such that the outer edge 344d of the sealing member 258d is in contact with and seals against the sidewall 286d of the fourth top portion 274d. In this embodiment, the sealing member 258d may be inserted into the fourth top portion 274d, such as a plug or stopper, to seal the top 282d of the top portion 274d and thereby maintain the analyzer control fluid 262 within the rack tube 252 of the analyzer control device 250.

Shown in FIG. 7E is a fifth top portion 274e having a top 282e, a sidewall 286e, and a thread 348a. A sealing member 258e includes a bottom 324e, a top 328e, an inner surface 336e and an outer surface 332e. The inner surface 336a of the sealing member 258e is internally threaded such that the sealing member 258e may be threadably engaged with the fifth top portion 274e. In this embodiment, the sealing member 258e may be screwed onto the fifth top portion 274e to seal the top 282e of the top portion 274e and thereby maintain the analyzer control fluid 262 within the rack tube 252 of the analyzer control device 250.

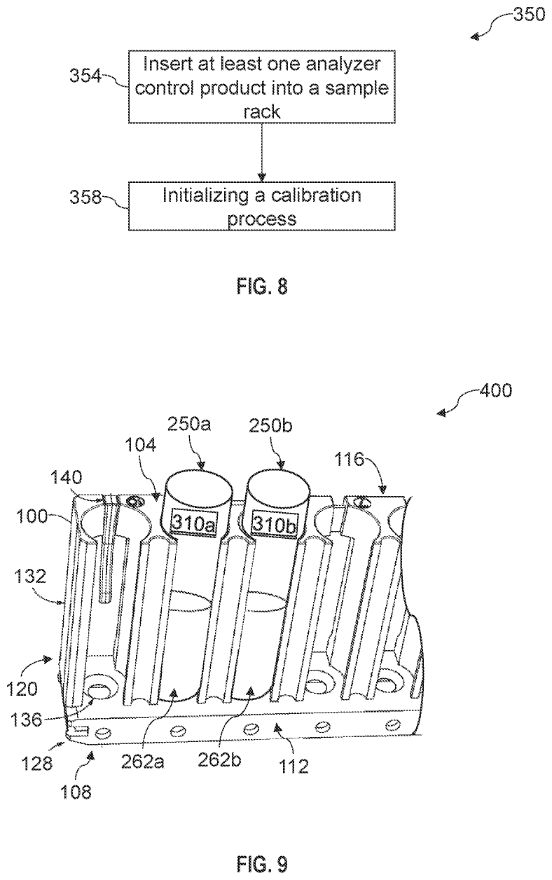

Referring now to FIG. 8, shown therein is a process diagram of a user instantiated calibration process 350 performed in accordance with the present disclosure. Generally, the user instantiated calibration process 350 includes the steps of inserting at least one analyzer control product 250 into a sample rack 30 (step 354) and initializing a calibration process on the sample analyzer system 10 (step 358).

In one embodiment, inserting at least one analyzer control product 250 into a sample rack 30 (step 354) includes inserting one or more analyzer control product 250 into the sample rack 30 and removing the sealing member 258 from the analyzer control product 250. In some embodiments, removing the sealing member 258 from the analyzer control product 250 can be performed before or after inserting the at least one analyzer control product 250 into the sample rack 30 (step 354).

In some embodiments, inserting at least one analyzer control product 250 into the sample rack 30 (step 354) does not include removing the sealing member 258. In these embodiments, either the analysis performed by the analyzer device 14 does not require direct access to the analyzer control fluid 262 in the analyzer control product 250 or the analyzer device 14 includes an access member (not shown) operable to access the analyzer control fluid 262 while the sealing member 258 is in place and sealed against the rack tube 254. The access member can be a pipette configured to pierce the sealing member 258 and draw the analyzer control fluid 262 from the rack tube 252.

In one embodiment, inserting at least one analyzer control product 250 into the sample rack 30 (step 354) further includes inserting at least one analyzer control product 250 having the threshold indicator 306 into the sample rack 30 and verifying that the volume of the analyzer control fluid 262 within the analyzer control product 250 is substantially equal to, or greater than, a minimum volume of the analyzer control fluid required as indicated by the threshold indicator 306.

In one embodiment, initializing a calibration process on the sample analyzer system 10 (step 358) includes initializing the calibration process by interacting with the input device 162 of the computing device 18. In one embodiment, the user initializes the calibration process on the sample analyzer system 10 by accessing the input device 162 of the computing device 18.

Referring now to FIG. 9, shown therein is a perspective view of an exemplary embodiment of an analyzer control product kit 400. Various embodiments of the present disclosure are drawn towards the analyzer control product kit 400. The analyzer control product kit 400 may include one or more analyzer control product 250a-n, shown in FIG. 9 as a first analyzer control product 250a and a second analyzer control product 250b. Each of the analyzer control product 250a-n in the analyzer control product kit 400 may include the same analyzer control fluid 262 or may include different analyzer control fluid 262. For example, the analyzer control product kit 400 may include the first analyzer control product 250a having a first analyzer control fluid 262a having one or more first analyte and the second analyzer control product 250b having a second analyzer control fluid 262b having one or more second analyte where the one or more first analyte is different from the one or more second analyte.

In one embodiment, where each analyzer control product 250a-n includes the identifier 310, the first analyzer control product 250a may have a first identifier 310a and the second analyzer control product 250b has a second identifier 310b where the first identifier 310a and the second identifier 310b are different and indicate that the first analyzer control product 250a has the first analyzer control fluid 262a while the second analyzer control product 250b has the second analyzer control fluid 262b. In one embodiment, where each analyzer control product 250a-n includes the identifier 310, the first analyzer control product 250a may have a first identifier 310a and the second analyzer control product 250b has a second identifier 310b where the first identifier 310a and the second identifier 310b are the same, indicating that the analyzer control fluid 262a in the first analyzer control product 250a and the analyzer control fluid 262b in the second analyzer control product 250b are the same analyzer control fluid 262.

In one embodiment, the analyzer control product kit 400 further includes the sample rack 30 having at least one analyzer control product 250a-n. The sample rack 30 of the analyzer control product kit 400 may be constructed as described above and generally include the rack body 100 defining the top surface 104, the bottom surface 108 opposite the top surface 104, the first side 112, and the second side 116 opposite the first side 112. The rack body 100 further includes the first end 120, and the second end 124 opposite the first end 120. The rack body 100 further includes the base portion 128 that defines the bottom surface 108, and the rack portion 132 that extends upwardly from the base portion 128. The rack portion 132 defines the top surface 104. The rack body 100 further defines at least one receptacle 136. Each receptacle 136 is sized and shaped to hold at least one analyzer control product 250a-n and may include a retention clip 140. The sample rack 30 may include 10 separate receptacles 136 as shown in FIG. 3. However, the sample rack 30 may include less than ten receptacles, such as one receptacle 136, or more than ten receptacles 136.

In one embodiment, the analyzer control product kit 400 may be loaded directly into the automated analyzer system 10. In one embodiment, the analyzer control product kit 400 may be loaded directly into the automated analyzer system 10 without requiring a user to add analyzer control fluid 262 to any of the analyzer control product 250a-n.

The analyzer control product kit 400 having the sample rack 30 may include a plurality of analyzer control products 250a-n, each received within a receptacle 136. Each of the plurality of analyzer control products 250a-n may have the same or different analyzer control fluid 262a-n or identifier 310, as described above.

It is to be understood that the steps disclosed herein may be performed simultaneously or in any desired order. Further, one or more steps may be further divided into one or more sub steps, and two or more steps or sub-steps may be combined in a single step, for example. Further, in some exemplary embodiments, one or more steps may be repeated one or more times, whether such repetition is carried out sequentially or interspersed by other steps or sub-steps. Additionally, one or more step or sub-steps may be carried out before, after, or between, the steps disclosed herein, for example.

From the above description, it is clear that the inventive concepts disclosed herein are well adapted to carry out the objects and to attain the advantages mentioned herein as well as those inherent in the inventive concepts disclosed herein. Therefore, the present disclosure overcomes the disadvantages and issues of the prior art including at least the issues of spillage, insufficient volumes of the analyzer control fluid, excessive volumes of the analyzer control fluid, and contamination of the analyzer control fluid.

For example, in one embodiment, a user may utilize the analyzer control product 250 without having to measure a volume of the analyzer control fluid 262. In one embodiment, the user may utilize the analyzer control product 250 without increasing the volume of the analyzer control fluid 262. In one embodiment, the user may utilize the analyzer control product 250 without using a bulk product of the analyzer control fluid 262, as required in the prior art. In one embodiment, the user may utilize the analyzer control product 250 without exposing the analyzer control fluid 262 to possible contaminants.

In one embodiment, the user may utilize the analyzer control product kit 400 without increasing the volume of the analyzer control fluid 262 in any of the analyzer control product 250a-n. In one embodiment, the user may utilize the analyzer control product kit 400 without measuring the volume of the analyzer control fluid 262 in any of the analyzer control product 250a-n. In one embodiment, the user may utilize the analyzer control product kit 400 without using a bulk product of the analyzer control fluid 262 with any of the analyzer control product 250a-n. In one embodiment, the user may utilize the analyzer control product kit without exposing the analyzer control fluid 262 in any of the analyzer control product 250a-n to contamination.

From the above description, it is clear that the inventive concepts disclosed herein are well adapted to carry out the objects and to attain the advantages mentioned herein as well as those inherent in the inventive concepts disclosed herein. While exemplary embodiments of the inventive concepts disclosed herein have been described for purposes of this disclosure, it will be understood that numerous changes may be made which will readily suggest themselves to those skilled in the art and which are accomplished within the scope of the inventive concepts disclosed and as defined in the appended claims.

What is claimed is:

1. An analyzer control product comprising:
a rack tube, comprising:
a base portion;
a top portion; and
a sidewall extending from the base portion to the top portion, the sidewall having an inner peripheral surface and an outer peripheral surface, at least one of the inner peripheral surface and the outer peripheral surface in contact with the base portion to form a control fluid void;
an analyzer control fluid within the control fluid void, the analyzer control fluid having a preconfigured volume; and
a sealing member attached to the top portion to seal the control void.

2. The analyzer control product of claim 1, wherein the rack tube further includes a threshold indicator disposed adjacent the outer peripheral surface, the threshold indicator configured to indicate a minimum volume of the analyzer control fluid.

3. The analyzer control product of claim 1, wherein rack tube further includes an identifier disposed adjacent the outer peripheral surface, the identifier configured to indicate one or more of a lot number, an expiration date, and an expected range.

4. The analyzer control product of claim 1, wherein the rack tube further includes a threshold indicator disposed adjacent the inner peripheral surface, the threshold indicator configured to indicate a minimum volume of the analyzer control fluid.

5. The analyzer control product of claim 1, wherein the rack tube further includes an identifier disposed adjacent the inner peripheral surface, the identifier configured to indicate one or more of a lot number, an expiration date, and an expected range.

6. The analyzer control product of claim 1, wherein the rack tube sealing member is threadably engaged with the rack tube.

7. The analyzer control product of claim 1, wherein the sealing member includes a top surface, a bottom surface and a peripheral edge, and wherein the bottom surface of the sealing member is adhered to the top of the top portion to seal the control fluid void.

8. The analyzer control product of claim 1, wherein the top portion further includes a ridge formed circumferentially along the sidewall of the top portion and wherein the sealing member further includes an inside surface and an outside surface, the inside surface forming an inner void configured to receive the ridge of the top portion to seal the control fluid void.

9. The analyzer control product of claim 1, wherein the sealing member has a top surface, a bottom surface and a peripheral edge wherein the sealing member is sized such that the peripheral edge is in contact with the sidewall of the top portion to seal the control fluid void.

10. The analyzer control product of claim 1, wherein the sealing member further includes an inside surface and an outside surface, the inside surface configured to engage the sidewall of the top portion to seal the control fluid void.

11. A method of calibrating the analyzer system comprising:
placing at least one analyzer control product in a sample rack of a sample analyzer system, the at least one analyzer control product including a rack tube, comprising a base portion; a top portion and a sidewall extending from the base portion to the top portion, the sidewall having an inner peripheral surface and an outer peripheral surface, at least one of the inner peripheral surface and the outer peripheral surface in contact with the base portion to form a control fluid void; an analyzer control fluid within the control fluid void, the analyzer control fluid having a preconfigured volume; and a sealing member attached to the top portion to seal the control fluid void; and
initializing a calibration process of the sample analyzer system.

12. The method of claim 11, wherein the outer peripheral surface of the rack tube includes a threshold indicator, the threshold indicator configured to indicate a minimum volume of the analyzer control fluid, and further comprising verifying that the preconfigured volume of the control meets or exceeds the minimum volume of the control indicated by the threshold indicator.

13. An analyzer control kit comprising:
a sample rack configured to receive an analyzer control product; and
the analyzer control product, comprising:
a rack tube comprising:
a base portion;
a top portion; and
a sidewall extending from the base portion to the top portion, the sidewall having an inner peripheral surface and an outer peripheral surface, at least one of the inner peripheral surface and the outer peripheral surface in contact with the base portion to form a control fluid void;
an analyzer control fluid within the control fluid void, the analyzer control fluid having a preconfigured volume; and
a sealing member attached to the top portion to seal the control void.

14. The analyzer control kit of claim 13, wherein the sample rack is configured to receive more than one analyzer control product, the analyzer control product being a first analyzer control product, the rack tube being a first rack tube, the sealing member being a first sealing member, and the analyzer control fluid being a first analyzer control fluid, and further comprising a second analyzer control product comprising a second rack tube, a second analyzer control fluid, and a second sealing member.

15. The analyzer control kit of claim 14, wherein the first analyzer control fluid and the second analyzer control fluid are the same.

16. The analyzer control kit of claim 14, wherein the first analyzer control fluid and the second analyzer control fluid are different.

17. A rack tube, comprising:
a base portion;
a top portion; and
a sidewall extending from the base portion to the top portion, the sidewall having an inner peripheral surface and an outer peripheral surface, at least one of the inner peripheral surface and the outer peripheral surface in contact with the base portion to form a fluid void, a threshold indicator disposed adjacent the outer peripheral surface, the threshold indicator configured to indicate a minimum volume of at least one of a sample and an analyzer control fluid.
